(19) United States
(12) Patent Application Publication
(10) Pub. No.: US 2023/0168661 A1
(43) Pub. Date: Jun. 1, 2023

(54) INTELLIGENT OBJECT SEGMENTATION

(71) Applicant: International Business Machines Corporation, Armonk, NY (US)

(72) Inventors: Tushar Agrawal, West Fargo, ND (US); Martin G. Keen, Cary, NC (US); Sarbajit K. Rakshit, Kolkata (IN); Thomas Jefferson Sandridge, Tampa, FL (US)

(21) Appl. No.: 17/536,441

(22) Filed: Nov. 29, 2021

(51) Int. Cl. G05B 19/4099; B33Y 50/00; B29C 64/386

(52) U.S. Cl. CPC G05B 19/4099; B33Y 50/00; B29C 64/386; G05B 2219/35134; G05B 2219/49023

(57) ABSTRACT

A processor may receive a request associated with a 3D object. The processor may access a management database. The management database may include information associated with a transportation environment. The 3D object may be placed in the transportation environment. The processor may determine, from the information, whether there is enough space in the transportation environment to transport the 3D object. The processor may automatically generate, based on the determining, the 3D object.

### BACKGROUND

The present disclosure relates generally to the field of object management, and more specifically to intelligently segmenting an object for effective management.

The three-dimensional (3D) printing process builds a 3D object from a computer-aided design (CAD) model, usually by successively adding material layer-by-layer, which is why it is also called additive manufacturing. The term “3D printing” covers a variety of processes in which material is joined or solidified under computer control to create a 3D object, with material being added together (such as liquid molecules or powder grains being fused together), typically layer-by-layer. Accordingly, with use of 3D printing various complex structures and dimensions of said structures can be generated/created.

### SUMMARY

Embodiments of the present disclosure include a method, computer program product, and system for intelligent splitting of an object for effective management. A processor may receive a request associated with a 3D object. The processor may access a management database. The management database may include information associated with a transportation environment. The 3D object may be placed in the transportation environment. The processor may determine, from the information, whether there is enough space in the transportation environment to transport the 3D object. The processor may automatically generate, based on the determining, the 3D object.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for intelligent splitting of an object for effective management, in accordance with aspects of the present disclosure.

FIG. 2 illustrates a flowchart of an example method for intelligent splitting of an object for effective management, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of object management, and more specifically to intelligently segmenting an object for effective management. While the present disclosure is not necessarily limited to such applications, various aspects of the disclosure may be appreciated through a discussion of various examples using this context.

Currently, different shapes and dimensions of objects (e.g., products) can be ordered and/or a user (e.g., customer) can also provide customized shapes/dimensions for an object. In some embodiments, to generate/create such objects, the 3D printing process can be used. The 3D printing process builds a 3D object from a CAD model, usually by successively adding material layer-by-layer, which is why it is also called additive manufacturing. The term “3D printing” covers a variety of processes in which material is joined or solidified under computer control to generate/create a 3D object, with material being added together (such as liquid molecules or powder grains being fused together), typically layer-by-layer. In some embodiments, casting may be used to generate the 3D object. In such an embodiment, a case die is used for generating the 3D object.

Accordingly, 3D printing/printers can be used for generation of various complex structures and/or various dimensions of structures, such as, using a 3D printer to generate a very small piece used in a piece furniture, or for manufacturing larger objects. However, some issues currently arise with the generation of 3D objects, most notably is that handling and transportation (e.g., sometimes collectively referred to herein as management) of larger and/or irregular shaped 3D manufactured objects can be difficult. Further, as the 3D object can be customized based on user choice/input, the shape can be irregular and may create difficulty for transportation or handling, such as when a user needs to carry the 3D object through a narrow passage.

Accordingly, there is a need for a solution by which when a larger customized 3D object is to be manufactured and needs delivery, then the solution will dynamically split (e.g., segment) a 3D model (e.g., simulation) of the 3D object, so that efficient transportation of the 3D object and assembly of the 3D object can be determined; this will further reduce associated transportation costs. As such, disclosed herein is such as solution, by which, when a large/irregular 3D object is to be printed or manufactured and/or needs delivery and proper handling, the proposed solution may dynamically split the 3D object so that both transportation and handling of the 3D object can be done in an efficient manner without compromising the quality and strength of the 3D object. In this instance, when an receiving a request associated with a 3D object (e.g., order), the proposed solution may receive an image, or video feed, of passage from where the 3D object needs to be handled, and accordingly optimize the segmentation (e.g., so that the 3D object is split in such a way that it can be transported and put through passage with little to no hinderance).

Before turning to the intricacies of the proposed solution, it may be beneficial to discuss the proposed solution by way of example. Accordingly, consider an order that has an irregular shaped chair with a particular size (e.g., a user defined design/shape). Similarly, multiple other customers have also ordered user defined designs of different, or the same, product (e.g., the chair). Now the manufacturer(s) will be manufacturing the orders individually, but if the products are printed individually, then there will be a wastage of space during transportation. In such an example, the proposed solution may identify the available space in the transportation vehicle (e.g., transportation environment) and will be splitting/segmenting the products that are to be manufactured so that maximum vehicle space can be utilized during transportation. The solution may further maintain the required structural strength of the products to determine where/how to split and/or generate/regenerate one or more 3D models of individual split portions as transportation space is filled (e.g., portion one of object A should be put in X location, where portion two of object B should be put in Y location, etc.).

The novelties of the proposed solution are as follows:

Considering the usage purpose of the 3D object, need of transportation, number of items are to be transported (e.g., both segments, pieces, sections, etc. of the 3D object, and the 3D object and other 3D objects), etc., the proposed solution may estimate the wastage of space in the transportation vehicle, and accordingly the proposed solution may identify how the 3D object is to be split into multiple segments/sections during manufacturing so that maximum space utilization can be achieved in the transportation vehicle;

While splitting the 3D object during manufacturing, the proposed solution may identify how the 3D object is to be split into multiple segments during manufacturing and also maintain the required structural strength in the 3D object;

While receiving an online order of a 3D object, or machined parts are to be manufactured, the proposed solution may analyze the shape and/or dimension(s) of the 3D object, and accordingly, based on an available passage for handling and/or transportation (e.g., management) need of the 3D object, the proposed solution may perform appropriate segmentation/splitting of the 3D object for proper handling and transportation;

The proposed solution may analyze the 3D object and logically split a 3D model (e.g., simulation, of the 3D object) such that 3D printers can print the received orders (e.g., requests associated with [generation] of a 3D object) in multiple sections, which can ensure ease of transportation and assembling of the 3D object;

While the 3D object is to be split, a 3D printer of the proposed solution may dynamically modify each split portion and may create/generate an assembly and locking mechanism (e.g. one or more assembly mechanisms) with 3D printing, such that during assembly, the individual parts can be (re)assembled and can ensure proper locking and strength of the completed 3D object (e.g., the object with all sections/segments complied together);

While any 3D object is to be manufactured, the proposed solution may also receive the shape and dimension(s) of one or more packages (e.g., used to transport the 3D object or sections of the 3D object), and accordingly based on the shape and dimension(s) of the one or more packages, the proposed solution may split the 3D model of the 3D object into multiple segments so that packaging can be done within the defined shape of the package; and

While the 3D object is manufactured in parts (e.g., sections, segments, etc.), then the proposed solution can use an augmented reality/virtual reality system to show how the 3D object can be manufactured into multiple segments and how each segment can be placed inside a package.

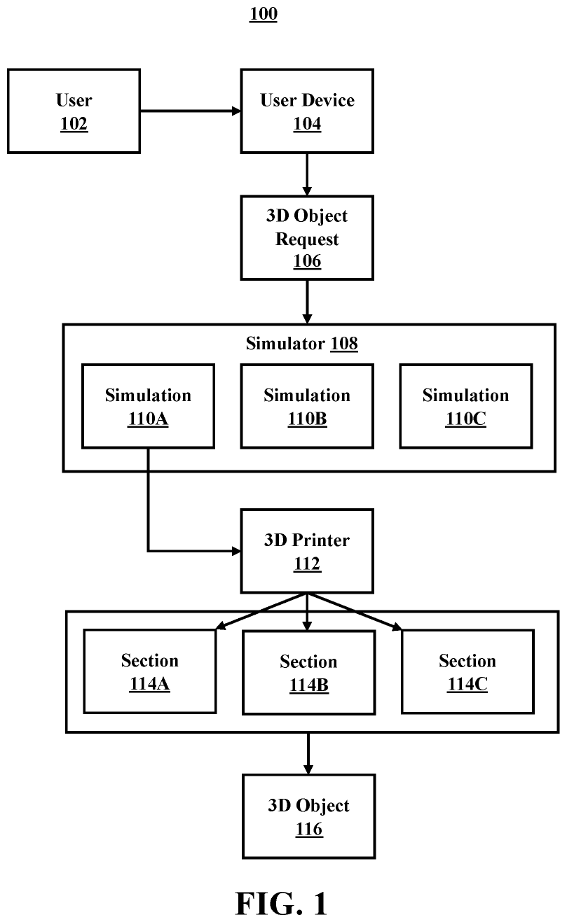

Referring now to FIG. 1, illustrated is a block diagram of an example system 100 for intelligent splitting of an object for effective management, in accordance with aspects of the present disclosure. As depicted, system 100 includes a user 102, a user device 104, a 3D object quest 106, a simulator 108, a 3D printer 112, sections 114A-C, and a 3D object 106. In some embodiments, the simulator 108 generates/includes simulations 110A-C.

In some embodiments, the user 102 interacts with the user device 104 to generate a 3D object request 106. In some embodiments, the 3D object request 106 includes an order for a user 102 customized object and/or a large object (e.g., an object not readily movable without machine help and/or an object that cannot fit with a transportation environment/vehicle). In some embodiments, the 3D object request 106 is sent to the simulator 108, where the simulator 108 generates simulation 110A-C. The simulations 110A-C may each include a model of the 3D object that is requested in the 3D object request 106, where each model depicts the 3D object split in various locations and/or those 3D splits placed in packages and in a transportation environment (not shown). The transportation environment could be identified from a manufacturer that is generating the 3D object and/or historic information on how the 3D object is transported.

In some embodiments, an optimal simulation, e.g., simulation 110A as exemplary depicted, may be sent to the 3D printer 112. In some embodiments, simulation 110A may be selected/determined as optimal as all sections of the split 3D object can be efficiently transported and assembled (as based on the simulation 110A). In some embodiments, the 3D printer 112, based on the simulation 110A, may generate sections 114A-C of the 3D object. In some embodiments, after transportation of the sections 114A-C, the 3D object 116 may be assembled using the sections 114A-C.

Turing now to a more in-depth look at the implementation steps utilized by the system 100:

Stage 1: Order placement and transportation analysis:

The system 100 can receive 3D printing requirements (e.g., the 3D object request 106) from any user 102, and accordingly the system 100 can print the 3D object 116 and a plan for delivery;

If the dimension(s) of any object 116 is too large or too irregularly shaped for adequate management (e.g., transport and/or handling), then handling a single 3D manufactured piece (e.g., the 3D object 116 as a whole, singular piece) will be difficult. The difficulty may arise during transportation and/or handling of the 3D object 116;

When any 3D manufactured object (e.g., 116) is ordered online (e.g., the 3D object request 106 is generated and/or received), then the system 100 may identify a difficulty in transporting the 3D object 116 as a single piece, or a difficulty in the user 102 having to handle the 3D object 116 as a single piece;

The user 102 can initiate multi-piece segmentation or the 3D printer 112 service provider can show/automatically perform multi-piece segmentation (based on simulations 110A-C of the simulator 108).

Stage 2: User specified customization analysis:

If the user 102 approves the 3D object 116 to be split into multiple sections 114A-C, then the user 102 may be asked to capture video and/or images of the doors, passage, state cases, elevators, etc. and share/send the video/images to the system 100 for processing;

The system 100 may identify the dimension(s) of the passage(s) so that the delivered 3D object 116 can be efficiently handled (e.g., in the sections 114A-C);

The system 100 may analyze the dimension(s) of the 3D object 116 and may compare the dimension(s) of the 3D object 116 with the available passage for handling, area for movement, etc.

Stage 3: Object segmentation determination:

The system 100 or the 3D printer 112 may identify how the 3D object 116 can be segmented so that the 3D object 116 can be handled through the defined passage;

The dimension(s) of each segment/section 114A-C may be analyzed and the system 100 may identify how the 3D object 116 can be split so that the 3D object can be handled within the defined passage;

While ordering any 3D object 116 (via the 3D object request 106), the user 102 can also specify the dimension(s) of packages (used for transport of the sections 114A-C or the 3D object 116 as a whole);

The user 102 can specify dimension(s) of one or more packages with a hand gesture or can visually show the packages (e.g., and the dimension(s) could be automatically identified by a dimension identification too);

The system 100 may receive the dimension(s) of the packages where the 3D object 116 (or sections 114A-C) can be packed;

The 3D printer 112 may split the 3D object 116 into sections 114A-C and may simulate (with simulator 108) how the sections 114A-C can be accommodated inside the packages as specified by the user 102;

The user 102 may be notified if the 3D object 116 and/or the sections 114A-C cannot be packed inside any defined package(s) and accordingly the system 100 may notify the user 102 to increase the dimension(s) of the package(s) or increase the number of packages;

The system 100 utilizing the simulator 108 may simulate how the 3D object 116 can be split so that the 3D object 116 or the sections 114B-C can be packed inside any defined package(s).

Stage 4: Object rendering, printing, and packaging:

The user 102 may be shown the dimension(s) and/or shape of each and every section 114A-C, and the user 102 may have the flexibility to merge and/or split one or more portions of the sections 114A-C within any of the simulations 110A-C (e.g., 3D models), and accordingly the system 100 may modify the package(s) (e.g., placement of the newly split one or more portions of the sections 114A-C);

Once the dimension(s) of split one or more portions are identified, then the system 100 may start printing, via the 3D printer 112, the 3D object as the multiple sections 114A-C;

Each and every section 114A-C may be identified uniquely, and each end of each section 114A-C may have an assembly and locking mechanism so that the sections 114A-C can be assembled together;

The 3D object 116 may be manufactured with/as the multiple sections 114A-C so that a required 3D object request (e.g., order) can be delivered within the defined package(s) or space (e.g., transportation vehicle/environment) available;

During assembling, the system 100 can use augmented reality (AR) glasses/devices, and accordingly the user 102 may be able to identify how the individual parts (e.g., sections 114A-C) can be assembled;

Based on structural analysis the system 100 may identify how the 3D object 116 can be split into the sections 114A-C and be assembled such that the 3D object 116 retains its required strength;

Based on historical analysis of structural failure, types of failure, and/or transportation difficulty, with respect to shape and dimension(s) of the 3D object 116, the system 100 can generate/create a knowledge corpus to identify different types of failure (which can help in increasing the speed of segmenting subsequent 3D objects and/or decrease the processing power needed in finding how to segment subsequent 3D objects that are the same or similar to the 3D object 116).

It is noted that although only simulations 110A-C and sections 114A-C are depicted, any number of simulations and/or sections can be generated by the system 100.

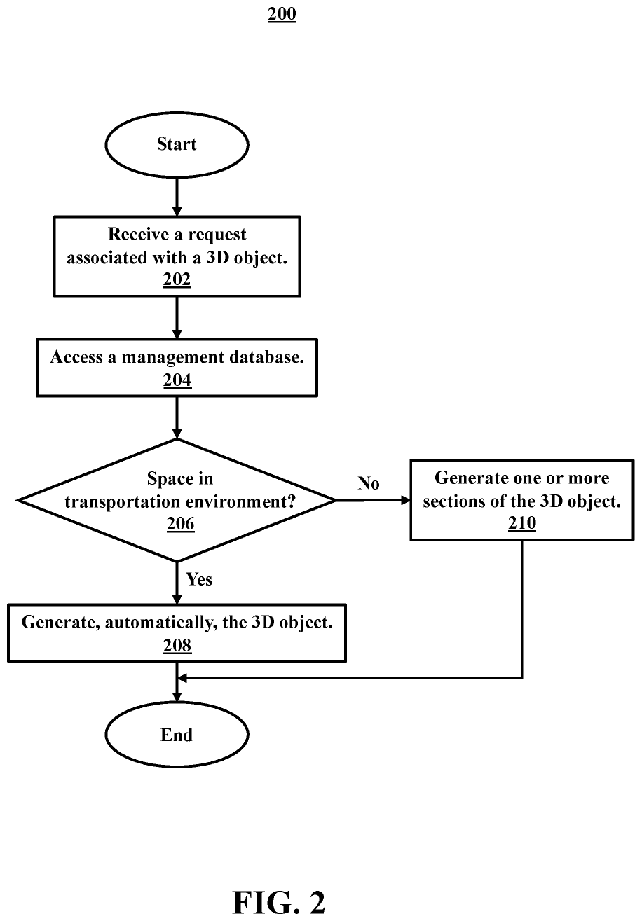

Referring now to FIG. 2, illustrated is a flowchart of an example method 200 for intelligent splitting of an object for effective management, in accordance with aspects of the present disclosure. In some embodiments, the method 200 may be performed by a processor (e.g., of system 100, etc.).

In some embodiments, the method 200 begins at operation 202, where the processor receives a request (e.g., order) associated with a 3D object. In some embodiments, the method 200 proceeds to operation 204, where the processor accesses a management (e.g., transportation and handling) database. In some embodiments, the management database may include information (e.g., manuals, blueprints, etc.) associated with a transportation environment (e.g., vehicle, package, etc.). In some embodiments, the 3D object may be placed in the transportation environment.

In some embodiments, the method 300 proceeds to decision block 206, where the processor determines whether there is enough space in the transportation environment to transport the 3D object. If, at decision block 206, it is determined that there is enough space in the transportation environment, the method 200 proceeds to operation 208. At operation 208, the processor automatically generates the 3D object. In some embodiments, after operation 208, the method 200 may end.

If, at decision block 206, it is determined that there is not enough space in the transportation environment, the method 200 proceeds to operation 210. At operation 210, the processor generates one or more sections of the 3D object. In some embodiments, after operation 210, the method 200 may end. In other embodiments, after operation 210, the method 200 may proceed to operation 208 where the entire 3D object may automatically be generated/assembled.

In some embodiments, discussed below, there are one or more operations of the method 200 not depicted for the sake of brevity and which are discussed throughout this disclosure. Accordingly, in some embodiments, determining whether there is enough space in the transportation environment to transport the 3D object may include the processor analyzing one or more attributes (e.g., dimensions, parts, etc.) of the 3D object and analyzing one or more attributes of passage (e.g., doorways, stairs, thresholds etc.) and packaging for/of the 3D object.

In some embodiments, the processor may further identify that there is not enough space in the transportation environment and generate one or more simulations. The one or more simulations may include splitting the 3D object in/at multiple locations. The processor may identify, from the one or more simulations, one or more specific locations to split the 3D object.

In some embodiments, the processor may generate an optimal simulation. The optimal simulation may depict the 3D object split at the one or more specific locations (so that the 3D object can be efficiently transported and handled). The processor may display the optimal simulation to a user.

In some embodiments, the processor may generate (e.g., print, 3D print, etc.) the 3D object. The 3D object may be generated in one or more sections as based on the split(s) in the one or more specific locations.

In some embodiments, the processor may generate one or more assembly mechanisms. The one or more assembly mechanisms may respectively connect the one or more sections. The processor may orient the one or more sections and the one or more assembly mechanisms in one or more packages (e.g., assembly pieces at one end of a section to attach to another end of another section, a first package stacked on top of a second package that houses sections of the 3D object that are to be connect, etc.).

In some embodiments, the processor may generate an augmented reality assembly instruction and provide the augmented reality assembly instruction to the user (e.g., provide instructions on how to connect the sections together to generate the full 3D object). In some embodiments, the augmented reality assembly instruction may provide visual cues to the user on where and how to orient and connect the sections, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

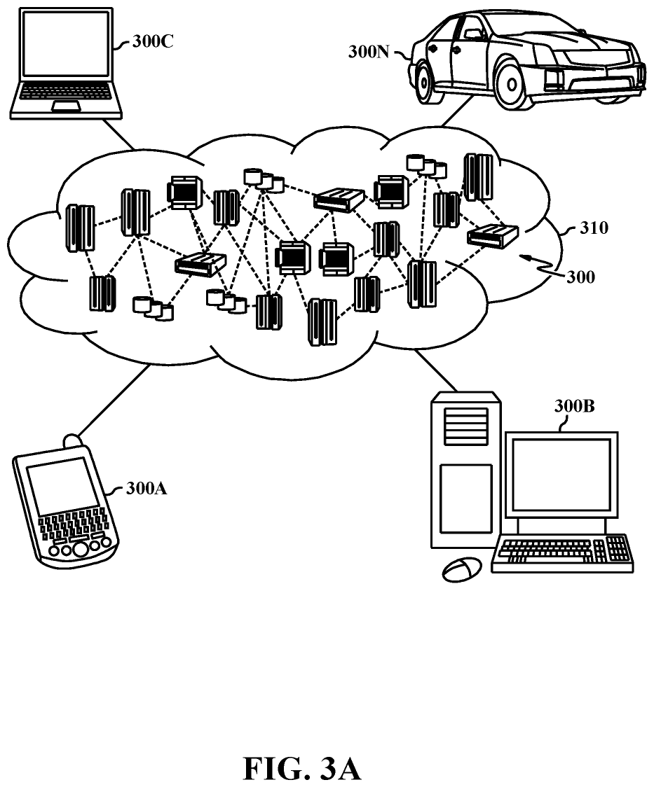

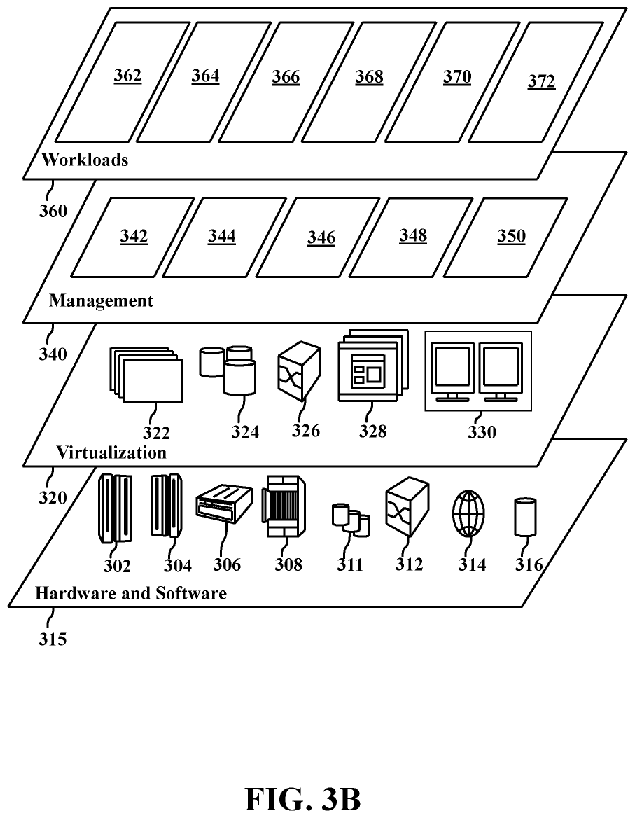

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and intelligently splitting of an object for effective management 372.

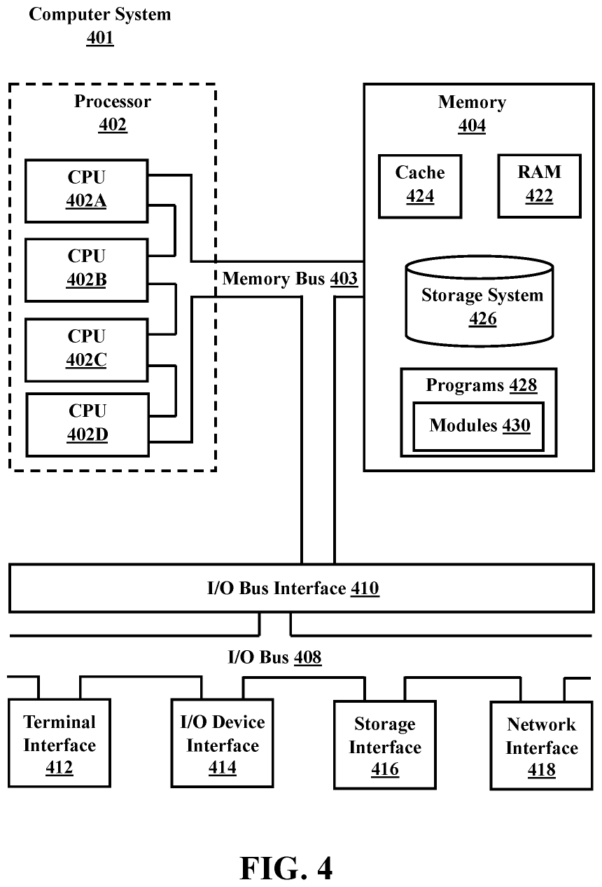

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for intelligent splitting of an object for effective management, the system comprising:
a memory; and
a processor in communication with the memory, the processor being configured to perform operations comprising:
receiving a request associated with a three-dimensional (3D) object;
accessing a management database, wherein the management database includes information associated with a transportation environment, and wherein the 3D object will be placed in the transportation environment;
determining, from the information, whether there is enough space in the transportation environment to transport the 3D object; and
generating, automatically, based on the determining, the 3D object.

2. The system of claim 1, wherein determining whether there is enough space in the transportation environment to transport the 3D object includes:
analyzing one or more attributes of the 3D object; and
analyzing one or more attributes of passage and packaging for the 3D object.

3. The system of claim 2, wherein the processor is further configured to perform operations comprising:
identifying that there is not enough space in the transportation environment;
generating one or more simulations, wherein the one or more simulations include splitting the 3D object in multiple locations; and
identifying, from the one or more simulations, one or more specific locations to split the 3D object.

4. The system of claim 3, wherein the processor is further configured to perform operations comprising:
generating an optimal simulation, wherein the optimal simulation depicts the 3D object split at the one or more specific locations; and
displaying the optimal simulation to a user.

5. The system of claim 4, wherein the processor is further configured to perform operations comprising:
generating the 3D object, wherein the 3D object is generated in one or more sections as based on the split in the one or more specific locations.

6. The system of claim 5, wherein the processor is further configured to perform operations comprising:
generating one or more assembly mechanisms, wherein the one or more assembly mechanisms respectively connect the one or more sections; and
orienting the one or more sections and the one or more assembly mechanisms in one or more packages.

7. The system of claim 6, wherein the processor is further configured to perform operations comprising:
generating an augmented reality assembly instruction; and
providing the augmented reality assembly instruction to the user.

8. A computer-implemented method for intelligent splitting of an object for effective management, the method comprising:
receiving, by a processor, a request associated with a three-dimensional (3D) object;
accessing a management database, wherein the management database includes information associated with a transportation environment, and wherein the 3D object will be placed in the transportation environment;
determining, from the information, whether there is enough space in the transportation environment to transport the 3D object; and
generating, automatically, based on the determining, the 3D object.

9. The computer-implemented method of claim 8, wherein determining whether there is enough space in the transportation environment to transport the 3D object includes:
analyzing one or more attributes of the 3D object; and
analyzing one or more attributes of passage and packaging for the 3D object.

10. The computer-implemented method of claim 9, further comprising:
identifying that there is not enough space in the transportation environment;
generating one or more simulations, wherein the one or more simulations include splitting the 3D object in multiple locations; and
identifying, from the one or more simulations, one or more specific locations to split the 3D object.

11. The computer-implemented method of claim 10, further comprising:
generating an optimal simulation, wherein the optimal simulation depicts the 3D object split at the one or more specific locations; and
displaying the optimal simulation to a user.

12. The computer-implemented method of claim 11, further comprising:
generating the 3D object, wherein the 3D object is generated in one or more sections as based on the split in the one or more specific locations.

13. The computer-implemented method of claim 12, further comprising:
generating one or more assembly mechanisms, wherein the one or more assembly mechanisms respectively connect the one or more sections; and
orienting the one or more sections and the one or more assembly mechanisms in one or more packages.

14. The computer-implemented method of claim 13, further comprising:
generating an augmented reality assembly instruction; and
providing the augmented reality assembly instruction to the user.

15. A computer program product for intelligent splitting of an object for effective management comprising a computer readable storage medium having program instructions embodied therewith, the program instructions executable by a processor to cause the processor to perform operations, the operations comprising:
receiving a request associated with a three-dimensional (3D) object;
accessing a management database, wherein the management database includes information associated with a transportation environment, and wherein the 3D object will be placed in the transportation environment;
determining, from the information, whether there is enough space in the transportation environment to transport the 3D object; and
generating, automatically, based on the determining, the 3D object.

16. The computer program product of claim 15, wherein determining whether there is enough space in the transportation environment to transport the 3D object includes:
analyzing one or more attributes of the 3D object; and
analyzing one or more attributes of passage and packaging for the 3D object.

17. The computer program product of claim 16, wherein the processor is further configured to perform operations comprising:
identifying that there is not enough space in the transportation environment; and
generating one or more simulations, wherein the one or more simulations include splitting the 3D object in multiple locations; and
identifying, from the one or more simulations, one or more specific locations to split the 3D object.

18. The computer program product of claim 17, wherein the processor is further configured to perform operations comprising:
generating an optimal simulation, wherein the optimal simulation depicts the 3D object split at the one or more specific locations; and
displaying the optimal simulation to a user.

19. The computer program product of claim 18, wherein the processor is further configured to perform operations comprising:
generating the 3D object, wherein the 3D object is generated in one or more sections as based on the split in the one or more specific locations.

20. The computer program product of claim 19, wherein the processor is further configured to perform operations comprising:
generating one or more assembly mechanisms, wherein the one or more assembly mechanisms respectively connect the one or more sections;
orienting the one or more sections and the one or more assembly mechanisms in one or more packages;
generating an augmented reality assembly instruction; and
providing the augmented reality assembly instruction to the user.
